(19) United States
(12) Patent Application Publication
(10) Pub. No.: US 2001/0012606 A1
(43) Pub. Date: Aug. 9, 2001

(54) IMPLANT BODY AND ROTATORY BODY

(76) Inventor: HEINZ-DIETER UNGER, OSNABRUECK (DE)

Correspondence Address: FRANK J. JORDAN, ESQ., JORDAN AND HAMBURG LLP, 122 EAST 42ND STREET, SUITE 4000, NEW YORK, NY, 10168, US

(21) Appl. No.: 09/381,267

(22) PCT Filed: Mar. 19, 1998
(86) PCT No.: PCT/EP98/01610

§ 371 Date: None

(30) Foreign Application Priority Data
Mar. 20, 1997 (DE) 297 05 059.1

(51) Int. Cl. A61C 8/00

(52) U.S. Cl. 433/173

(57) ABSTRACT

The invention relates to a rotatory body (3, 203, 17), in particular part of an implant body (1, 101, 201, 301), that penetrates a jaw bone, and has a central internal channel (15, 25) which completely pierces the rotatory body (3, 203, 17) along its axial extension.

The invention relates to a rotatory body that cuts into a jaw bone, in accordance with the preamble of claim 1, as well to an implant body in accordance with the preamble of claim 15.

In implantology, a bore, which extends over the insertion length of the implant body to be introduced later, is usually first made in the jaw bone, in order to put an implant body into place. The implant body to be put into place can have a self-tapping outside thread, with which it is anchored in the bore previously made. Likewise, even a self-tapping implant body cannot be put into place without a pilot bore, rather the bore can merely have a smaller diameter than the implant to be screwed in.

It is also possible to produce a bore with the full length and width of the implant body, which is then filled by an implant body that can be expanded in the bore.

However, all these methods of procedure require that a bore is placed in the jaw bone, which bore essentially already has the full length of the implant body, and therefore is usually in the range of about 6 to about 16 mm deep. This results in the danger that under critical anatomical conditions, the mandibular canal, i.e. the maxillary sinus, will be perforated while the bore is being made. This cannot be prevented by -taking X-rays, since they show only a two-dimensional image of the anatomical conditions, and also show the actual conditions on an enlarged scale. Even when using a three-dimensional imaging process, for example a tomographic process, an injury to the structures in question would only be precluded if the bore were to be made with sufficient precision to be able to reliably circumvent the structures seen in the image.

In practice, however, thee is no three-dimensional imaging process available, nor could the bore follow the precision of this structural information, since it is produced by hand and therefore is subject to a corresponding tolerance.

Therefore production of a bore to hold an implant is a great risk, particularly for an inexperienced implantologist, which frequently has the result that patients who require implants are referred to a few special clinics.

U.S. Pat. No. 5,108,288 discloses an implant device in which a sleeve part is placed into a bore in the jaw bone, and this sleeve part serves to support a screw that projects basally over the length of the sleeve part and engages in the bone there. However, the sleeve part is not fixed in place in the bone, and while the screw holding the implant is screwed in, the sleeve part is insufficiently supported and prevented from rotating. There are also problems if such a device must be removed again, for example in order to treat a bone inflammation. According to this reference, too, a pilot bore must be produced for the insertion length of the screw.

The invention is based on the problem of creating implant bodies and tools with which the risk of injury to the patient is reduced and implantation, as a whole, is made easier, and with which reliability is increased and the possibility of treating symptoms in the bone without completely replacing the implant is created.

The invention solves this problem with the characteristics of claim 1, i.e. with the characteristics of claim 11 and claim 26. With regard to other advantageous developments, reference is made to claims 2 to 10, 12 to 25, and 27 to 28.

By fitting a rotary body, for example an internal part of an implant, with an internal channel that runs coaxial to its axis of rotation, which completely penetrates the internal part, it is possible to introduce a fiber optic into the internal channel, for example, in order to be able to optically perceive when the tip of the part of the implant body being screwed in approaches a blood vessel or the end of a bone in the region of a maxillary sinus, or even a mucous membrane, while this internal part is being screwed in. In this manner, the process can be stopped at the proper time while the internal part is being screwed in, in case the anatomical conditions do not permit deeper anchoring in the bone.

In place of the fiber optic, a measurement wire can also be arranged in the internal channel while the internal part is being screwed in, with its apical end structured as an electrode that is in contact with the region of the tissue to be removed, measuring the difference in potential relative to a reference potential. If a blood vessel is injured, and particularly if a nerve is injured, the measure potential difference changes suddenly, so that the therapist can immediately stop screwing the internal part in further.

If it turns out, while the implant part is being screwed in, that the planned length of the implant body cannot be used, the planned internal part can be exchanged for a shorter one.

If the internal part of the implant has such an internal channel, this can also be used for later treatment of a bone inflammation in the region of the implant tip (apical ostitis), in that the fiber optic of a laser, for example an Nd-Yag laser, is introduced into the internal channel and the laser light can become active in the region of the implant tip, where it serves to kill germs.

Treatment with medication is also possible through this internal channel, if the lentula of a handpiece for applying medication to the region of the implant tip is used. It is possible to seal such an internal channel with a pin, in order to prevent entry of bacteria. A gutta percha pin would be a possibility, for example.

Such an internal channel of a rotatory body can be used not only for an internal part of an implant body, but also for the most varied rotary bodies that cut into the jaw bone, even for rapidly rotating drills.

For example, it is possible to first make a bore in the jaw bone, using such a rotatory body, with constant optical monitoring of the tip of the bore, in order to subsequently place a screw into the bore produced in this way, which then no longer bears the risk of possibly causing an injury to blood vessels or the maxillary sinus.

Also in the case of an implant body according to one of claims 11 to 25, a preliminary bore can first be made via a screw body provided with an internal channel, which body is supported in the sleeve part and advanced by hand, where after the preliminary bore has been made with such a screw body, the latter can be removed and a final internal part, either with or without an internal channel, can be put into place.

Such a screw body, which is used in this manner, can have a glass-like front end piece, for example, which does not hinder the use of a fiber optic, but which makes the strength of the bore tip similar to that of a metal drill. Subsequently, an internal part can then be screwed in, which has an internal channel without an end element, for example, so that this part again can be used for administering medication or laser treatment, in the manner indicated, if this should become necessary. Both the screw body for pre-drilling the bore and the internal part are axially and radially supported in the sleeve part, so that lateral play of the part to be screwed in is reduced to almost zero, on the one hand, and, due to the axial bracing against the sleeve part, motorized pre-drilling can be avoided in every case, except for the short sleeve part. In every case, the pre-drilling instrument or the internal part can be screwed in by hand, and the bone resistance can be felt at all times while the part is being screwed in.

Also, the screw body can form an inspection body, which has an essentially complete glass-like tip, which can be screwed into the pre-cut thread, where a lens is arranged within the glass-like tip, through which optical inspection can take place, not only of the tip of the pre-cut thread, but also of the side walls of this region, with regard to possible injury to blood vessels or nerves. Such a rotatory body would be used after use of the hand drill to cut the thread, and would be removed again before use of the internal part of the implant.

By structuring a sleeve part according to the invention, which can be placed in the bone, as well as an internal part that projects basally beyond the sleeve part and is anchored in the jaw bone, the possibility is created of undertaking preliminary work on the bone, which formerly related to the entire length of the implant body to be put into place, merely in the region of the insertion length of the sleeve part, which makes up only part of the insertion length of the implant body. Due to the anchoring part, which can be moved towards the outside, the sleeve part is supported both with regard to rotational forces, particularly while the internal part is being screwed in, and with regard to axial tensile forces.

If expansion wings are provided, particularly in the coronal region of the sleeve part, pressure acts on the surrounding bone here, so that healing is promoted.

The structure of a sleeve part, anchored and secured to prevent rotation, furthermore offers the advantage that the internal part supported in the sleeve part can be removed again at any time, and that in this way, access to the opening in the bone which holds the implant body is possible through the sleeve part, with this access reaching to the tip of the implant body.

This makes it possible, for example, to treat a cyst formation in the region of the implant tip, where excochleation of the cyst that has formed can take place by means of a sharp spoon or the like, through the sleeve part, and, if there is still sufficient bone material available at the bottom, a longer internal part can be screwed into the channel, or, if there is insufficient bone material available, the channel can be narrowed with substitute bone material or the patient's own bone, in such a way that an internal part with the previous dimensions is again reliably anchored.

Preferably, a bore only has to be made in the jaw bone to hold the sleeve part, while the internal part is structured as a self-tapping screw body in its basal part that projects beyond the sleeve part in the installed state of the parts, and that can be secured in the jaw bone by being slowly screwed into it. The production of a bore can therefore be limited to the axial length of the sleeve part, which preferably amounts to 30 to 70% of the insertion length of the implant body in the jaw bone. The risk of damaging blood vessels, or of perforating a nerve or the maxillary sinus, is therefore significantly reduced. Usually, the axial length of the sleeve part will take up about half the entire length of the implant body, so that with a total implant length of 10 mm, for example, a bore with a depth of only 5 mm has to be made beforehand. This means that the sleeve part is seated in the region of the hard corticalis, so that it is securely anchored in the bone tissue.

The risk of injury is not only reduced by the lesser depth of the bore that is made, however, but also because the internal part is slowly screwed in with its basal part, into the region of the jaw bone which projects beyond the bore. Differing from the use of an electric drill, which functions at a high speed of rotation, the internal part, which is preferably provided with a self-tapping outside thread and has a conical shape in its basal part, is slowly screwed into the jaw using a ratchet, where any change in resistance of the bone material which occurs as the screw is being screwed in, using a hand tool, particularly a ratchet, can be immediately perceived by the therapist performing the treatment.

Screwing the internal part into the bone without having to first provide a bore is made possible in that the internal part is supported in the sleeve part while it is being screwed in, and is therefore free of radial play, on the one hand, since the sleeve part is supported laterally in the bore in the jaw bone that was made to hold the sleeve part. On the other hand, the faces of the sleeve part are axially supported on the front end of the bore previously made, so that when the internal part is screwed into the bone, there is an axial brace between the internal part and the sleeve part. Because of this axial and radial wedging of the sleeve part, it is possible to screw the self-tapping screw body into place. In contrast, screwing a screw body into the bone free-hand, without any force-absorbing guide, is practically impossible, particularly under difficult anatomical conditions, since contact with particularly hard bone trabeculae or with spongy regions will result in lateral displacement of the screw body.

Preferably, the sleeve part is structured as a basally closed ring body, which has expansion wings in its coronal region, where the expansion wings are deployed by screwing in the internal part, and therefore they additionally assure the support of the sleeve part in the bore. Furthermore, this opens up the possibility of being able to tighten the sleeve part if periimplantitis occurs, accompanied by softening of the bone in the coronal region of the implant, thereby securely anchoring the sleeve part in its coronal region again.

In addition, it is possible to introduce bone material or substitute bone material into the jaw bone through the bore, via an inserted sleeve. This can become necessary, for example, if the bone is very thin or if there is a risk of perforation of the maxillary sinus when a part is screwed in deeply. Likewise it is possible, if the bone is perforated lingually or labially when a pre-cutting instrument to be supported in the sleeve part is screwed in, to apply bone material and/or substitute bone material also to this perforated site, via the sleeve part of the implant. Because there is a mucous membrane which covers the perforation site towards the outside, healing of the bone material or substitute bone material is possible without problems here. Therefore, an intentional perforation of the bone in the lingual region can even be aimed at according to this method, in order to preclude damage to the nervus mandibularis. Nerve displacement is therefore not necessary, and the risks related to it (numb lip) can be avoided. The bone material or substitute bone material applied via the sleeve part can seal a lateral perforation or a hole drilled into the maxillary sinus, in such a stable way that it is possible to screw the implant body into this bone material or substitute bone material. Depending on the conditions, the bone material or substitute bone material can be introduced first and the sleeve can be provided with a healing cap at first, or the implant body can be directly screwed into the bone material or substitute bone material that has been introduced, and fixed in place there.

Further advantages and details are evident from the drawing and the following description of several exemplary embodiments of the object of the invention.

The drawing shows:

FIG. 1 an implant body according to the invention, in a side view, in partial cross-section,

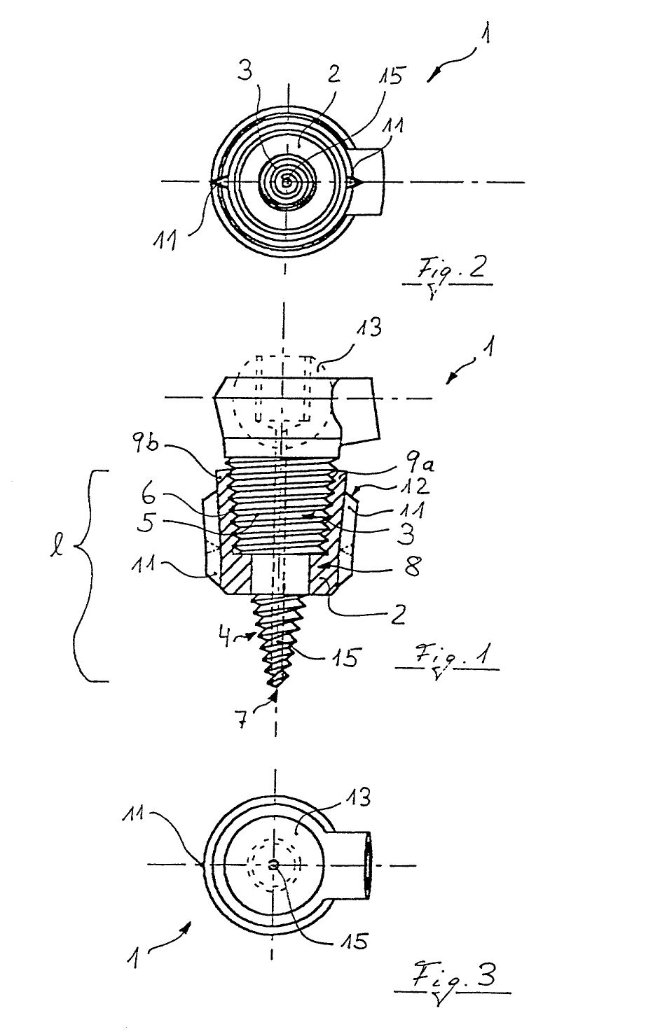

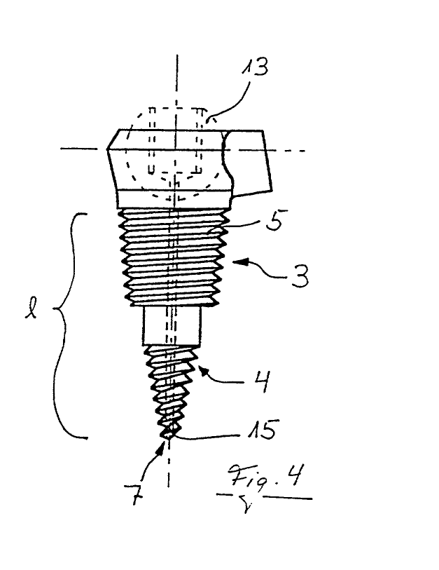

FIG. 2 the implant body according to FIG. 1, in a view from the bottom,

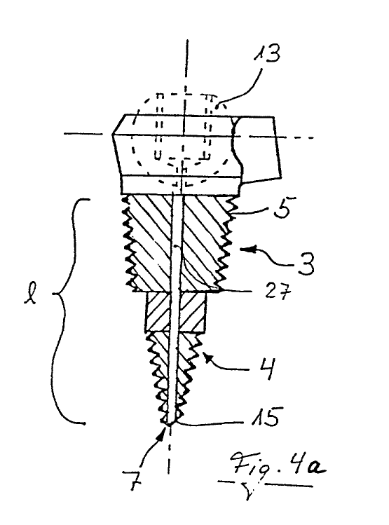

FIG. 3 the implant body according to FIG. 1, in a view from the top,

FIG. 4 the internal part of the implant body according to FIG. 1,

FIG. 4a a cross-sectional view of the internal part according to FIG. 4 with a gutta percha pin to seal the central inspection channel,

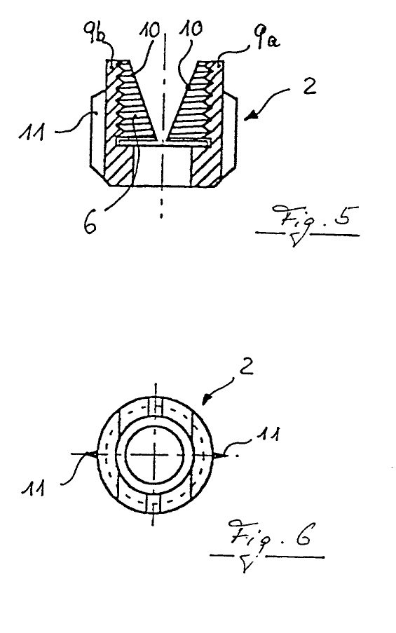

FIG. 5 the sleeve part of the implant body according to FIG. 1 in lengthwise cross-section,

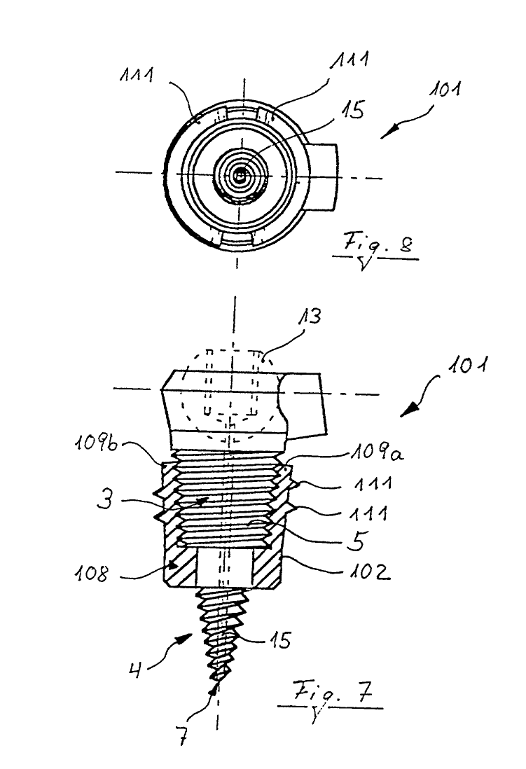

FIG. 6 the sleeve part according to FIG. 5, in a view from the top,

FIG. 7 a view similar to FIG. 1, of an alternative implant body with laterally projecting thread channels,

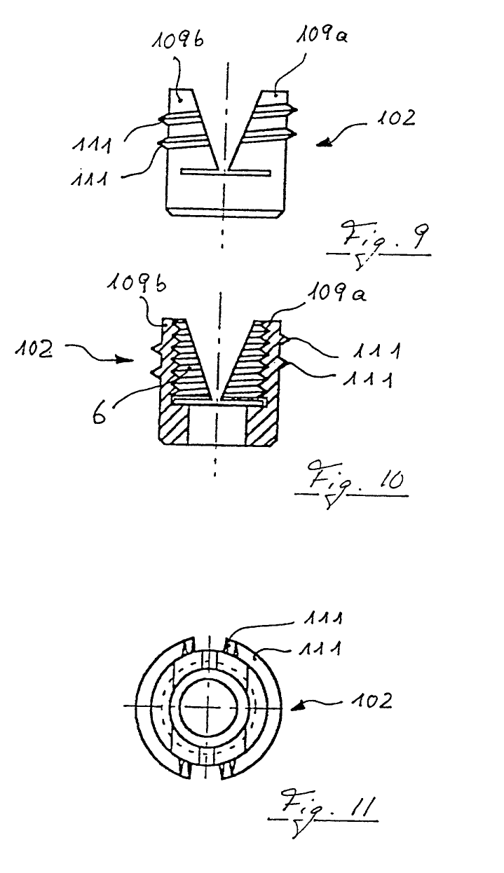

FIG. 8 the implant body according to FIG. 7, in a view from the bottom,

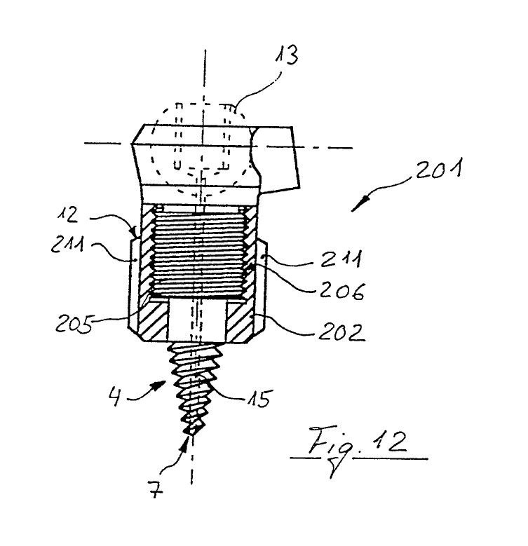

FIG. 9 the sleeve part of the implant body according to FIG. 7, in a side view,

FIG. 10 the sleeve part according to FIG. 9, in lengthwise cross-section,

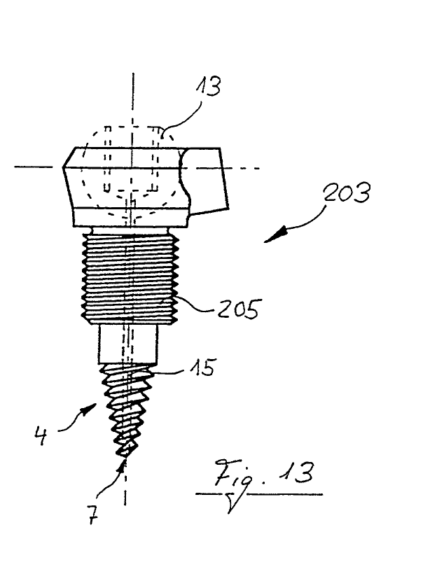

FIG. 11 the sleeve part according to FIG. 10, in a view from the top,

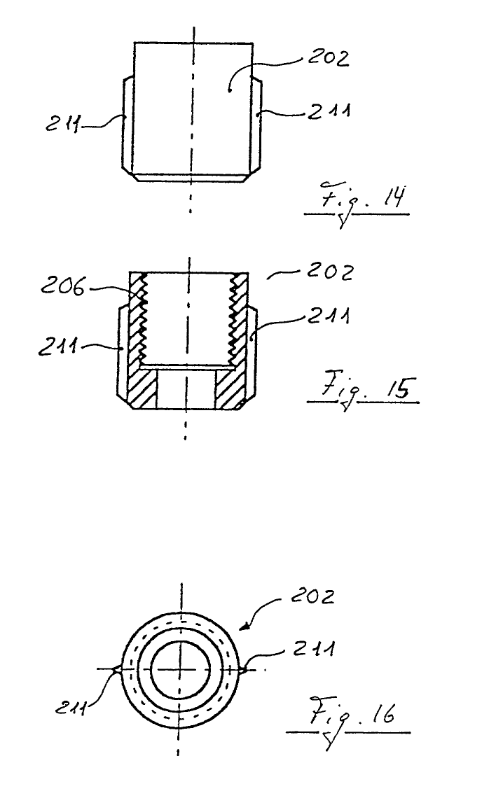

FIG. 12 another alternative embodiment of an implant body in a view similar to FIG. 1,

FIG. 13 the internal part of the implant body according to FIG. 12,

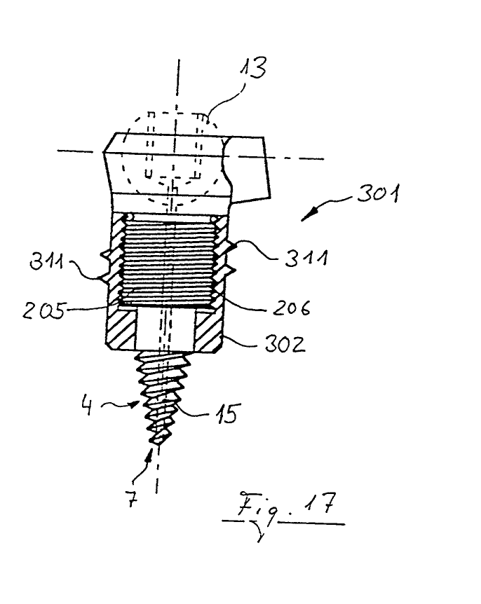

FIG. 14 the sleeve part of the implant body according to FIG. 12, in a side view,

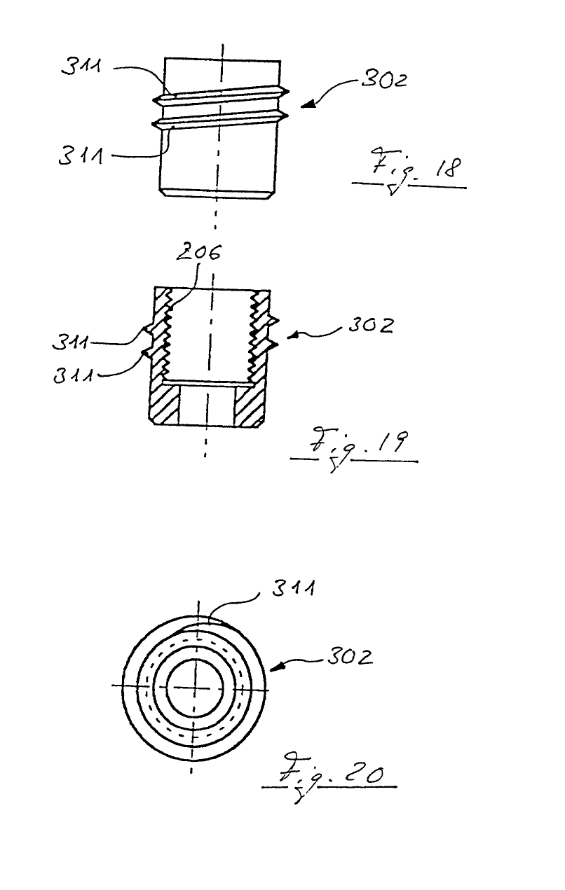

FIG. 15 the sleeve part according to FIG. 14, in lengthwise cross-section,

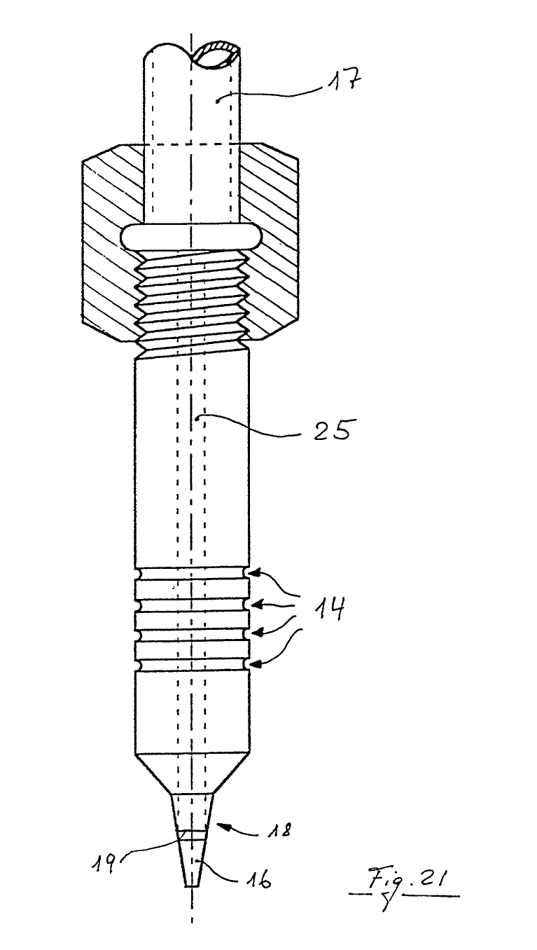

FIG. 16 the sleeve part according to FIG. 14, in a view from the top,

FIG. 17 an implant body similar to FIG. 12, with lateral thread channels,

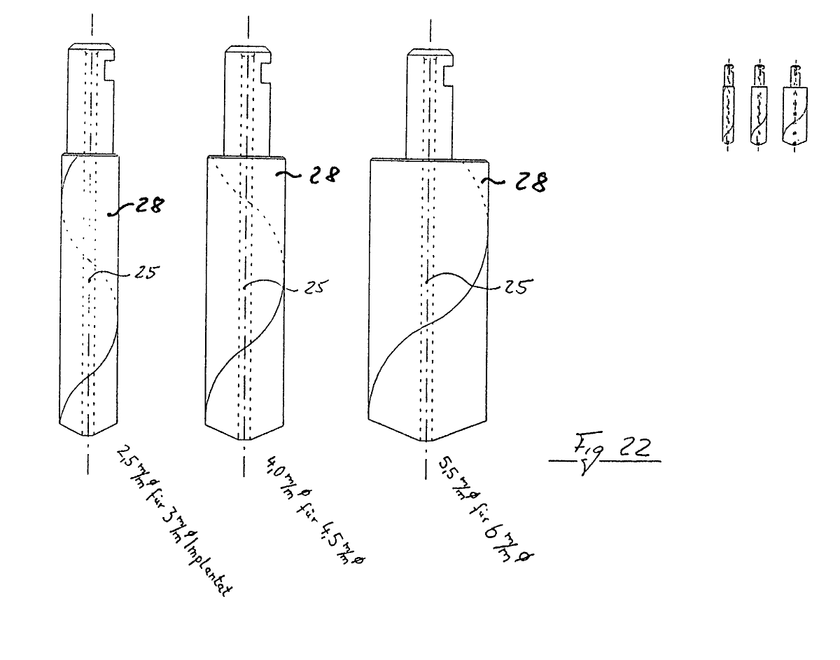

FIG. 18 the sleeve part of the implant body according to FIG. 17, in a side view,

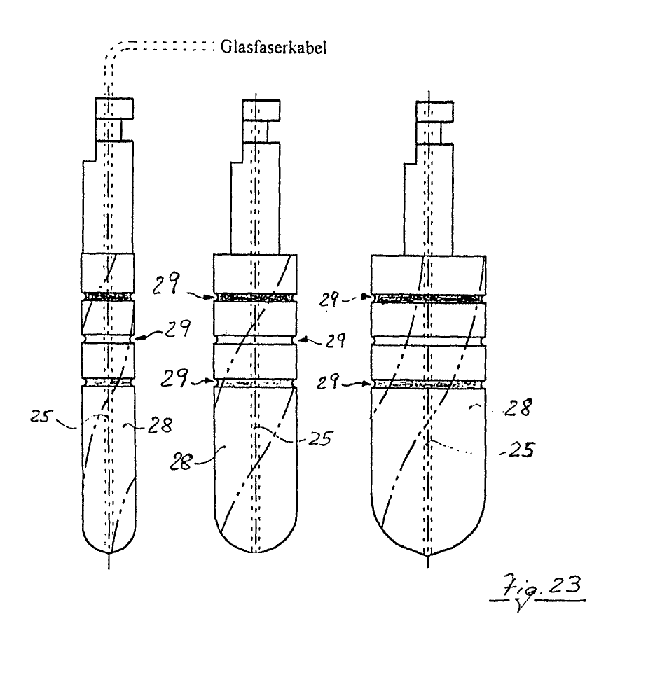

FIG. 19 the sleeve part according to FIG. 18, in lengthwise cross-section,

FIG. 20 the sleeve part according to FIG. 19, in a view from the top,

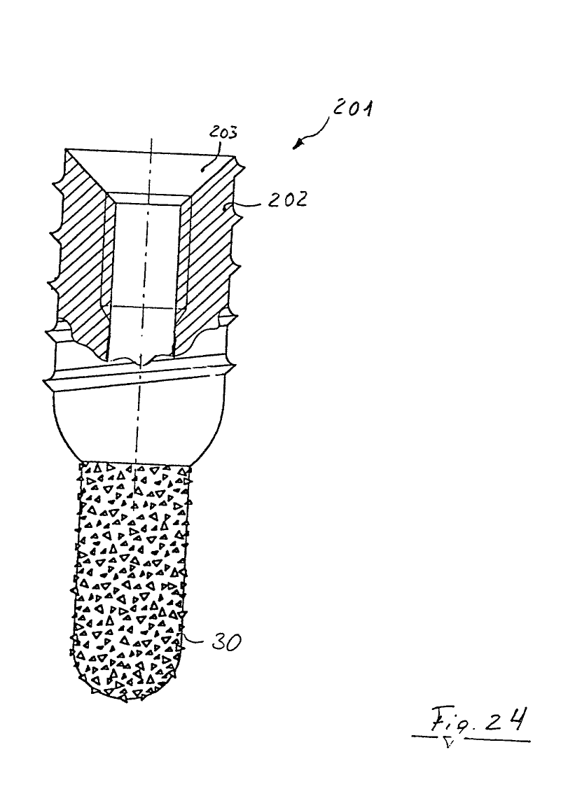

FIG. 21 a rotatory body for pre-drilling and inspecting a bone recess to hold an implant body,

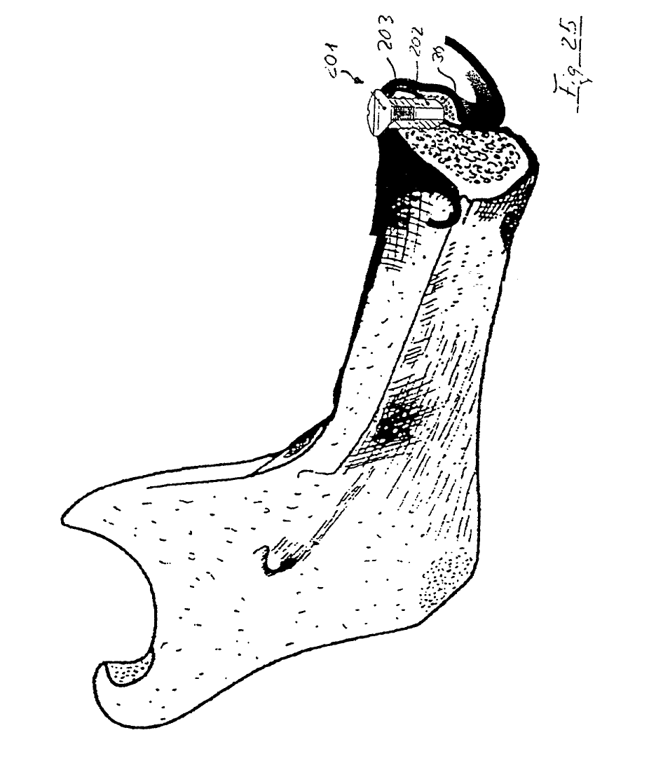

FIG. 22 a rotatory body structured as a pre-drilling element, with various diameters,

FIG. 23 various rotatory bodies structured as high-speed drills, with an internal channel and a fiber optic cable held in it, as well as with optical markings to determine the drilling depth,

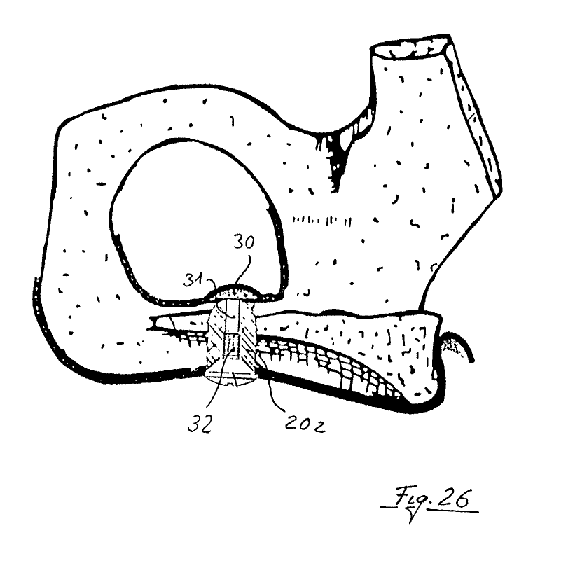

FIG. 24 an implant body with a secondary implant that can be screwed into a pin made of bone chips or substitute bone material,

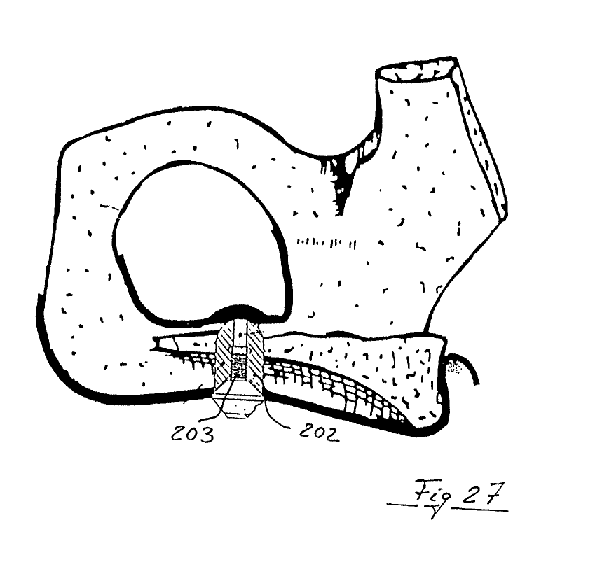

FIG. 25 a mandible, with a cut made in it, in which the bore perforates the bone labially, and the region between the perforation and the mucous membrane is filled with substitute bone material,

FIG. 26 a maxilla, with a perforated maxillary sinus, where substitute bone material was added in the region of the perforation, and a healing cap is held in the sleeve part,

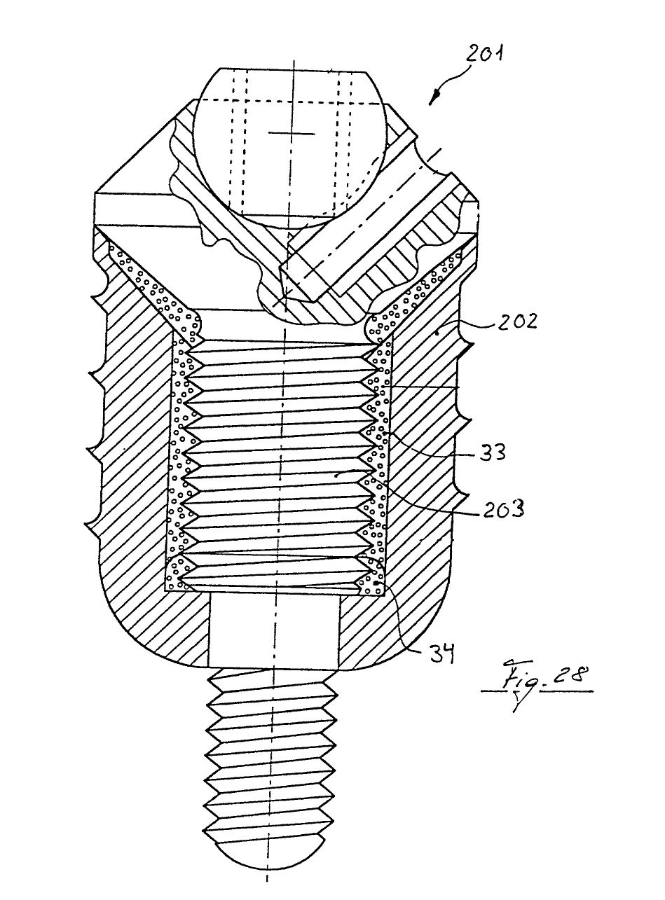

FIG. 27 a view similar to FIG. 26, with a sealing pin between the substitute bone material and a secondary implant,

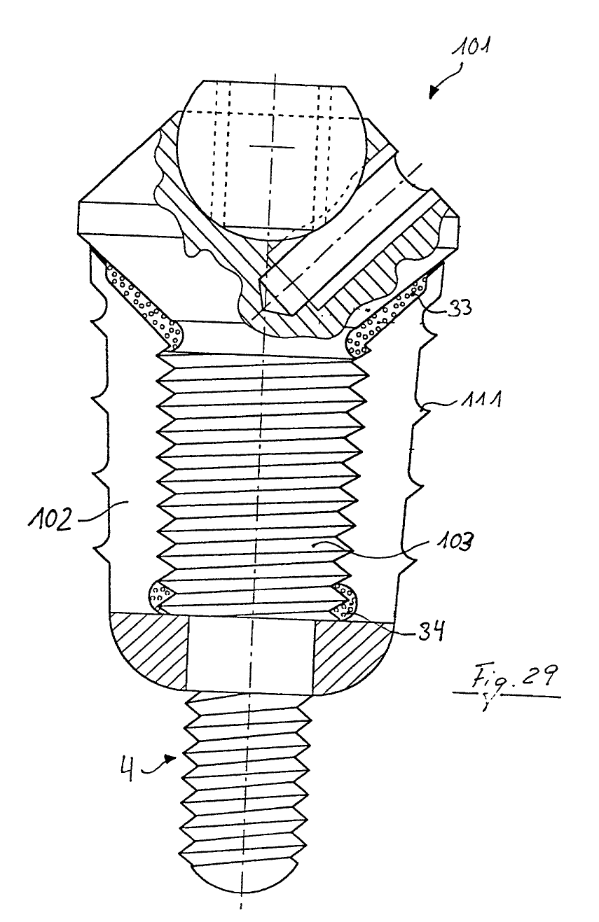

FIG. 28 a cylindrical implant body with a squeeze sleeve located between the thread of the secondary implant part and the primary implant part,

FIG. 29 a view similar to FIG. 28, with a conical implant body.

In detail, the implant body 1, 101, 201, 301 has a sleeve part 2, 102, 202, 302 forming a primary implant part, as well as an internal part 3, 203 forming a secondary implant part. The internal part 3, 203 is supported in the sleeve part 2, 102, 202, 302 over a partial region of its axial insertion length I in the jaw bone, and projects axially beyond the sleeve part 2, 102, 202, 302 with its basal portion 4, when the implant body 1, 101, 201, 301 is put into place, thereby being anchored in the jaw bone with this projecting portion 4. This basal, projecting portion 4 of the internal part 3, 103, 203, 303 is structured as a screw body provided with a self-tapping outside thread. In addition, the internal part 3, 103 is provided with a mechanical outside thread 5, 205 in the part that is its coronal region when placed into the jaw bone, with which it engages with an inside thread 6, 206 of the sleeve part 2, 102, 202, 302 and therefore can be supported in the latter. In total, the internal part 3, 203 represents a rotatory body that can be screwed into and unscrewed from the sleeve part 2, 102, 202, 302 and the bone, by means of a rotatory movement.

The axial length of the sleeve part 2, 102, 202, 302 makes up about

50% of the insertion length I of the implant body 1, 101, 201, 301 in the jaw bone, in the exemplary embodiments shown.

With the length ratio between the projecting partial region 4 of the internal part 3, 203 and the sleeve part 2, 102, 202, 302 it must be ensured, for one thing, that a sufficient length of the anchoring part 4 remains in the bone for a secure hold of the implant body 1, 101, 201, 301, in other words that the sleeve part 2, 102, 202, 302 does not take up too large a portion of the axial insertion length I, but on the other hand the sleeve part 2, 102, 202, 302 should take up a sufficient portion of the axial length I in order to guarantee reliable guidance of the internal part 3, 203 and to ensure that when the internal part 3, 203 is screwed into the sleeve part 2, 102, 202, 302, the tip 7 of the basal part 4 of the internal part 3, 203 does not penetrate into the bone tissue until at least one thread channel of the outside thread 5, 205 of the internal part 3, 203 has been supported in a thread channel 6, 206 of the sleeve part 2, 102, 202, 302.

The sleeve part 2, 102, 202, 302 will therefore take up 30 to 70% of the insertion length I of the implant body 1, 101, 201, 301 in the bone.

In a first and a second exemplary embodiment (FIG. 1 to FIG. 6 and FIG. 7 to FIG. 11), the sleeve part 2, 102 is structured as a ring body closed in its basal region 8, 108, followed by expansion wings 9a, 9b, 109a, 109b in the coronal direction. The sleeve part 2, 102 is nevertheless structured as a single-piece body. The expansion wings 9a, 9b, 109a, 109b are formed by incisions 10, 110 in the sleeve part 2, 102.

Internal parts 3 are provided for insertion into such sleeves 2, 102; the outside thread 5 of the former widens conically in the coronal direction, so that when the internal part 3 is screwed into the sleeve part 2, 102, the expansion wings 9a, 9b, 109a, 109b are caused to spread out, as described in detail below.

It is not compulsory, in this connection, that a sleeve part 2, 102 forms two expansion wings 9a, 9b or 109a, 109b, in each instance, rather a different number of expansion wings is also possible. If there are two expansion wings 9a, 9b or 109a, 109b, these will generally be arranged in a distal-mesial orientation in the jaw, in order to find the most sufficient and massive bone substance possible for support. In certain cases, for example if such an implant body 1, 101 is placed in the cavity formed by the root of a tooth, after extraction of a tooth, it might be better to put the sleeve part in place in a lingual-buccal orientation, since the root of the tooth leaves a cavity that extends in this direction.

In place of the expansion wings 9a, 9b, 109a, 109b as shown, different anchoring parts that can be moved outward are also possible for fixing the sleeve part 2, 102 in place, for example wedges that are guided in slit recesses of the sleeve part, or the like.

In order to guarantee a secure hold of the sleeve part 2, 102, 202, 302 in the bone, the part is provided with molded parts 11, 111, 211, 311, which are structured to be raised, and project on its outside wall.

The molded parts 11, 211 are structured as ribs that are wedge-shaped in cross-section, which represent a means to prevent rotation of the sleeve part 2, 202 when the internal part 3, 203 is screwed in or unscrewed, on the one hand, and, at the same time, act to secure the sleeve part 2, 202 axially. In this connection, the coronal ends 12, 212 of the molded ribs 11, 211 are axially at a distance from the coronal end of the sleeve part 2, 212, so that there is bone tissue, at least after a certain healing time, both basal to the ribs 11, 211 and coronal to the top ends 12, 212, and the ribs therefore represent a support for the sleeve parts 2, 202 with regard to tensile stresses on the implant body 1, 201 that can occur.

In the case of the sleeve parts 2 that can widen conically, the ribs 11 can be structured in multiple parts (shown with broken lines in FIG. 1), in order not to stand in the way of expansion.

The same dual function of both preventing rotation and securing the sleeve part 102, 302 axially is fulfilled there by the molded thread channels 111, 311, which also form a wedge-shaped cross-section and screw into the bone in self-tapping manner. In this connection, it is not necessary that the sleeve part 102,302 is completely surrounded by an outside thread, rather one to two thread channels 111, 311 on the outside of the sleeve part 102, 302 are sufficient.

In additional exemplary embodiments (FIG. 12 to FIG. 16 and FIG. 17 to FIG. 20), the internal part 203 has a cylindrical outside thread 205, the sleeve part 202, 302 is structured with a corresponding cylindrical shape, and is not widened even when the internal part 203 is being screwed in. The axial and radial hold of the sleeve part 202, 302 is guaranteed, in this connection, by the fact that the bore which holds the sleeve part 202, 302 is of a lesser size, on the one hand, and by the molded parts 211, 311 on the outside.

In its coronal region that projects beyond the bone, the internal part 3, 203 is provided with engagement surfaces for a rotatory tool, for example a ratchet, by means of which the internal part 3, 203 can be screwed into the sleeve part 2, 102, 202, 302 by hand. For this purpose, an extension can be formed, in addition, so that when the part is screwed in, the lever arm of the ratchet can be moved above the surrounding teeth, in every case, so that the internal part 3, 203 can be screwed in even under difficult spatial conditions.

The internal part 3, 203 is structured as an anchor for prosthetic supraconstructions, where a ball adapter 13, provided in the coronal part of the internal part 3, 203, can particularly serve for this purpose. Other attachment possibilities for the supraconstruction, particularly tooth replacements, are also possible.

In order to be able to determine the penetration depth of the internal part 3, 203 into the bone, on the one hand, and to put in a similar or a different internal part 3, 203 into the bone, to the same depth, after unscrewing the internal part 3, 203, in reproducible manner, optical markings 14 are applied to the internal part 3, 203 and/or to the sleeve part 2, 102, 202, 203, which can be used to verify the insertion depth. These markings can be structured as circumferential rings, or as vertical markings, arranged offset over the internal part, which can be brought into coverage with counterparts on the sleeve part 2, 102, 202, 302.

When the internal part 3, 203 is screwed into the sleeve part 2, 102, 202, 302, the basal region of the outside thread 5, 205 first engages with a thread channel in the coronal region of the inside thread 6, 206 of the sleeve part 2, 102, 202, 302, before the tip 7 of the internal part 3, 203 hits the basal bottom of the bore made previously for insertion of the sleeve part 2, 102, 202, 302. This contact with the base of the bore can be felt as resistance, which signals to the therapist that from this point on, the internal part 3, 203, or a pre-drilling instrument being used first, the dimensions of which correspond to the internal part 3 to be inserted, and which is also screwed in by hand, is being screwed in.

In the case of the first two exemplary embodiments, the sleeve part 2, 102 expands sideways in its coronal region with the expansion wings 91, 9b or 109a, 109b, as the internal part 3, 203 is being screwed in further and further, so that this results in anchoring the sleeve part 2, 102 against the lateral walls of the bore previously made.

However, this is not compulsory, rather the sleeve 202, 302 can be structured as a cylindrical, closed body, which is held firmly in the bore by the fact that the bore is slightly smaller, and by the molded parts 211, 311, and therefore does not require any expansion to anchor it laterally.

As the part 4 of the internal part 3, 203, which projects out of the sleeve part 2, 102, 202, 302 basally, is screwed in further and further, the sleeve part 2, 102, 202, 302 is increasingly wedged in the bore axially, since the thread channels of the self-tapping thread of the projecting part 4 of the internal part 3, 203 brace themselves axially in the bone, against the basal end surface of the sleeve part 2, 102, 202, 302. This guarantees a secure hold of the implant body 1, 101, 201, 301 both in the axial direction, to absorb chewing pressure and tensile stresses, and in the radial direction.

It is particularly advantageous if the internal part 3, 203 of the implant body 1, 101, 201, 301, which forms a rotatory body, has a continuous internal channel 15, 25, which penetrates the rotatory body 3, 203, 17 axially.

In this connection, the internal channel 15, 25 can run coaxial to the axis of rotation, but can also be at a slight slant to it, so that it runs in the edge region of the thread.

The internal channel can have an end element 16, 26 at the apical end 7.

Such an end element 16, 26 can be structured as a transparent, glass-like, and sealed end of the basal end 7 of the internal channel 15, 25. This creates a tip 7 that is structured as part of the screw body 4 being screwed in, and does not form any shape recesses relative to this body. The tip 7 can therefore participate in compressing the bone or in cutting and drilling through it, while the screwing-in process takes place.

The internal channel 15, 25 is provided to hold an endoscopic fiber optic, so that while the iriternal part 3, 203 is being screwed in, the tip 7 offers a possibility of optical inspection, in order to be able to perceive the bone structure in the region of this tip 7. If a blood vessel or a nerve is injured while the internal part 3, 203 is being screwed in, or if the internal part 3, 203 comes close to the mucous membrane or the maxillary sinus with its tip 7, this can be seen through the fiber optic placed in the internal channel 15, and the therapist can immediately stop screwing the internal part 3, 203 in further, since this is done by hand. If it should turn out, during the screwing-in process, that such an anatomical structure prevents the internal part from being screwed in further, without the planned insertion length I of the internal part 3, 203 in the bone having been reached, the internal part 3, 203 can be unscrewed again, to be replaced by a shorter, broader one.

Optical inspection of the tip 7 of the internal part 3, 203 by means of an endoscopic fiber optic is possible both if the basal end of the internal channel 15 is open, and if it is closed off by means of an end element 16 made of glass or another transparent material. Such fiber optics are available with diameters starting from about 0.3 mm.

Furthermore, the internal channel 15 can be used to hold the fiber optic of a laser, which can be used to perform treatment, for example of an apical ostitis, even if the implant body 1, 101, 201, 301 is in place, in that the laser fiber optic is introduced into the internal channel 15 and germs located in the region around the tip 7 of the internal part 3, 203 can be killed using the laser light.

Likewise, the internal channel 15 can serve to hold the lentula of a handpiece, making it possible to administer medication into the apical region through the internal channel 15, so that here again, this channel serves not only for optical inspection during forward movement or afterwards, but also for therapy of bone symptoms that until now required complete removal of the implant body.

The internal channel 15, arranged in an internal part 3, 203, can also be sealed off with a pin 27 after the implant body 1, 101, 201, 301 is put into place, in order to prevent entry of disease pathogens. The pin 27, for example a pin made of gutta percha or titanium, can be removed from the internal channel 15 if necessary.

Another possibility of checking the forward movement of the internal part 3, 203 with regard to injury, for example of nerves in the bone, is to introduce an electrically conductive measurement wire into the internal channel during the screwing-in process, and fixing it in place there; in the region of the basal tip 7 of the internal part 3, 203, an electrode is formed at the end of this wire, and used to measure a difference in potential relative to a reference potential, so that a voltage change can be measured as a dimension for the occurrence of different structures in the bone.

In particular, if the tip 7 hits a nerve, a clear change in voltage will occur, so that here again, the therapist can immediately interrupt the screwing-in process, without any injury to the nerve, since this process is being performed by hand, and it is advantageous that the tip 7 essentially exerts a compression effect, and this effect will not immediately result in a serious injury to the nerve.

Such an internal channel 15, 25 is possible not only with an internal part 3, 203 of an implant body 1, 101, 201, 301, but also for various other types of rotatory bodies, for example a high-speed drill that penetrates into the bone at several hundred revolutions per minute, or an inspection body 17.

In this connection, it is possible, for example, that the rotatory body 17 forms a manually activated or driven pre-drilling instrument, which is first screwed into the sleeve part 2, 102, 202, 302, and permits optical inspection of the bore being made by hand, through its basal end. Such a pre-drilling instrument, not shown in the drawing, can be provided both with an end element made of transparent material, in order to be able to form a glass-like, suitably hard tip, which participates in the drilling and compression process, in this way, or the internal channel in this pre-drilling instrument can be open basally. In any case, an internal channel of such a pre-drilling instrument is structured to hold a fiber optic or an electrically conductive potential measurement wire, which permits checking the bore. If anatomically critical structures occur, advancing movement can be stopped immediately when such a pre-drilling instrument is used.

For subsequent inspection of a bore that has been made, an inspection body 17 can be used, which penetrated into the bone after the pre-drilling instrument, in such a manner that it is screwed into the pre-drilled bone recess. For this purpose, the basal tip 19 of the inspection body 17 is structured as a glass body provided with an outside thread, which closes off the internal channel 25 basally. In this connection, the internal channel 25 additionally has an optical lens at its basal end, so that after the tip 18 is screwed into the bore cut by the screw thread of the pre-drilling instrument, not only the basal tip 7 of the implant body, but also the entire conical bore basal to the sleeve part 2, 102, 202, 302, is accessible for optical inspection. Therefore, if blood vessels or nerves are perforated not by the basal tip 17, but rather by a lateral part of the screw body, this can be determined using the inspection body 17. The inspection body 17 furthermore has optical markings in its shaft region, which permit a precise screwing-in depth in accordance with the preliminary bore.

After removal of the rotatory body 17, and if there are no findings of damage to the aforementioned structures, the final internal part 3, 203 can be screwed into the thread 6, 206 of the sleeve part 2, 102, 202, 302, where this internal part 3, 203 can have an internal channel 15, but does not have to have one under non-critical conditions.

Since the internal part 3, 203 is also structured as a rotatory body and fixed in place in the thread 6, 206 of the sleeve part 2, 102, 202, 302 with its thread 5, 205, it can be unscrewed again at any time, so that even in the case of a solid internal part without an internal channel 15, therapy of apical regions is possible without completely removing the entire implant body 1, 101, 201, 301, and the internal part 3, 203 can be screwed into the sleeve part 2, 102, 202, 302 again after the therapy has been performed.

An implant body 1, 101, 201, 301 according to the invention, as a whole, can be used both with or without a pre-drilling instrument for the internal part 3, 203.

A bore drilled with a motor is placed in the jaw bone only for the sleeve part 2, 102, 202, 302, but because of the short axial length of the sleeve part 2, 102, 202, 302, this bore is not critical with regard to injury to blood vessels, nerves, or the maxillary sinus.

The internal part 3, 203 is screwed in by hand, in any case, independent of whether or not a pre-drilling instrument was used.

If no pre-drilling instrument was used for the internal part 3, 203, it can be screwed in in a single working step, with optical inspection of the screwing-in process being possible at all times, using the said internal channel 15. Even if a pre-drilling instrument is used, this possibility of optical inspection is maintained, and the internal part 3, 203 which is to be inserted later can either have an internal channel 15, especially for therapy, or can be structured as a solid body, particularly in the case of non-critical bone structures.

FIG. 22 shows pre-drilling instruments with diameters of 2.5 mm, 4.0 mm, and 5.5. mm, which are used for implant diameters of 3.0 mm, 4.5 mm, and 6.0 mm.

The drills 28 can be provided with marking rings 29, in order to thereby be able to adjust the drilling depth in defined manner, as shown in FIG. 23. Such markings can be arranged, for example, at a drilling depth of 8 mm, 10 mm, 12, mm, and 14 mm. In order to make implantation possible even in problematic bone structures, it can be practical to perforate the bone either in the direction of the maxillary sinus (sinus maxillaris) in the case of the maxilla, or lingually or labially, on the side, and to fill the perforated site with bone material or substitute bone material 30, in order to allow stabilization of the anchoring base for the implant body 1, 101, 201, 301 in this way. The bone material or substitute bone material 30 can consist both of a complete bone chip, which was operated out of the bone at another site, using a hollow-cylinder milling tool, or also of bone chips or a synthetic material which is able, after a certain period of healing, to hold parts that are under mechanical stress, for example, a pin with bone material or substitute bone material 30 can be set onto the implant body 1, 101, 201, 301, as shown in FIG. 24.

It is also possible to introduce the substitute bone material 30 through the central channel formed by the sleeve part 2, 102, 202, 302, into the maxillary sinus or the region perforated laterally on the jaw bone, below the mucous membrane, in portions, and subsequently to place the secondary implant 3, 103, 203, 303. In this connection, as shown in FIG. 28, a sealing pin 31 for the substitute bone material 30 can first be provided, and a healing cap 32 can be inserted into the primary implant 2, 102, 202, 302 for a healing phase. Depending on the consistency of the bone material or substitute bone material 30, however, the secondary implant 3, 103, 203, 303 can also be put into place immediately, as shown in FIG. 27.

Independent of whether or not substitute bone material 30 is introduced, the thread between the primary implant 2, 102, 202, 302 and the secondary implant 3, 103, 203, 303 can be sealed using a sealing body 33, for example one made of titanium or plastic, which forms a circumferential ring 34 in its basal region, from which wing elements that can be expanded axially can extend, in order to allow it to stretch along with conical sleeves 102, 302. In the case of a cylindrical sleeve 2, 202, a continuous axial cuff can also continue the sealing body 33. If a sealing body 33 is used, a predrilling instrument is first used, which indicates the depth of its penetration into the bone using a scale ring that moves with it. After the pre-drilling instrument is removed, the position of the scale ring can be used to read off how deep the secondary implant part 3, 103, 203, 303 must be screwed into the sleeve part 2, 102, 202, 302, which serves as the primary implant part. While this final internal part 3, 103, 203, 303 is being screwed in, the sealing body 33 is placed between the primary and the secondary implant body, to produce a seal.

1. Implant body (1; 101; 201; 301) for placement, in particular, into human jaw bones, where the implant body (1; 101; 201; 301) is structured to support a supraconstruction, which represents at least apart of a tooth replacement, and comprises a sleeve part (2; 102; 202; 302) which can be placed into a bore in the jaw bone, as well as an internal part (3; 203) that can be supported, in some of its regions, in the sleeve part (2; 102; 202; 302), where the sleeve part (2; 102) is structured as a closed ring body (8; 108) over at least part of its insertion length, and comprises anchoring parts (9a, 9b; 109a, 109b) to hold it in place in the bone, which can be moved outward to engage with the wall of the bore in the jaw bone, characterized in that the internal part (3; 203) projects basally beyond the sleeve part (2; 102; 202; 302) in the installed state of the parts and is anchored in the jaw bone, and that the sleeve part (2; 102; 202; 302) has the closed ring body (8; 108) in its basal region and the anchoring parts (9a, 9b; 109a, 109b) in its coronal region.

2. Implant body according to claim 1, characterized in that the sleeve part (2; 102) has expansion wings (9a, 9b; 109a, 109b) in its coronal region as anchoring parts.

3. Implant body according to claim 2, characterized in that the sleeve part (2; 102) is structured in one piece and that the expansion wings (9a, 9b; 109a, 109b) are formed by incisions (10; 110) in its coronal wall region.

4. Implant body according to one of claims 1 to 3, characterized in that the sleeve part (2; 102; 202; 302) makes up 30 - 70% of the insertion length (I) of the implant body in the jaw bone.

5. Implant body according to one of claims 1 to 4, characterized in that the sleeve part (2; 102; 202; 302) is provided, on its outer wall, with molded parts (11; 111; 211; 311) that project out and engage into the bone.

6. Implant body according to claim 5, characterized in that the molded parts (11; 111; 211; 311) are structured as ribs which are wedge-shaped in cross-section, or as self-tapping thread channels.

7. Implant body according to one of claims 5 or 6, characterized in that the coronal end (12) of the molded parts (11; 111; 211; 311) demonstrates an axial distance from the coronal end of the sleeve part (2; 102; 202; 302).

8. Implant body according to one of claims 1 to 7, characterized in that the sleeve part (2; 102; 202; 302) has an inside thread (6; 206) and that the internal part (3; 203) has an outside thread (5; 205) complementary to the former.

9. Implant body according to one of claims 1 to 8, characterized in that the internal part (3; 203) is structured as a self-tapping screw body in its basal region (4)

10. Implant body according to one of claims 1 to 9, characterized in that the internal part (3) is structured conically in its coronal region.

11. Implant body according to one of claims 1 to 10, characterized in that the internal part (3; 203) is provided with engagement surfaces for a rotatory tool at its coronal end region.

12. Implant body according to one of claims 1 to 11, characterized in that the internal part (3; 203) is structured as an anchor for prosthetic supraconstructions.

13. Implant body according to one of claims 1 to 12, characterized in that the screw-in depth of the internal part (3; 203) can be verified using optical markings (14).

14. Implant body according to claim 13, characterized in that the optical markings (14) comprise marking parts arranged on the internal part (3; 203) and on the sleeve, which can be brought into coverage with each other.

15. Implant body according to one of claims 1 to 14, characterized in that the internal part (3; 203; 17) has a central internal channel (15; 25) that completely penetrates the internal part (3; 203′ 17) along its axial expanse.

1. Implant body according to claim 15, characterized in that the internal channel (15; 25) has an end element (16).

2. Implant body according to claim 16, characterized in that the end element (16) can be inserted into the internal channel (15; 25) and anchored in it.

18. Implant body according to one of claims 16 or 17, characterized in that the end element (16) is structured as a transparent, glass-like, sealed body at the basal and of the internal channel (15; 25).

19. Implant body according to one of claims 15 to 18, characterized in that the internal channel (15; 25) is structured to hold an endoscopic fiber optic.

20. Implant body according to claim 19, characterized in that an optical lens (19) is provided in the internal part (3; 203; 17), in the end region of the fiber optic.

21. Implant body according to one of claims 15 to 20, characterized in that the internal channel (15; 25) is structured to hold a laser fiber optic.

22. Implant body according to one of claims 15 to 21, characterized in that the internal channel (15; 25) is structured to hold a lentula for therapeutic treatment of a bone segment located in the basal region of the internal part (3; 203; 17) that is placed into the bone.

23. Implant body according to one of claims 15 to 22, characterized in that the internal channel (15; 25) is structured to hold a measurement wire to detect a difference in potential.
